(19) United States
(12) Patent Application Publication
(10) Pub. No.: US 2004/0072931 A1
(43) Pub. Date: Apr. 15, 2004

(54) Composition comprising a blocked polyisocyanate

(76) Inventors: Christoph Thiebes, Koln (DE); Christian Fussel, Tonisvorst (DE); Reinhard Halpaap, Odenthal (DE); Beate Baumbach, Burscheid (DE); Joachim Petzoldt, Monheim (DE); Karsten Danielmeier, Solingen (DE)

Correspondence Address: BAYER POLYMERS LLC, 100 BAYER ROAD, PITTSBURGH, PA, 15205, US

(21) Appl. No.: 10/600,016

(22) Filed: Jun. 20, 2003

(30) Foreign Application Priority Data
Jun. 27, 2002 (DE) 10228730.9

(51) Int. Cl. C08L 75/00

(52) U.S. Cl. 524/186; 524/189; 524/196

(57) ABSTRACT

Use of a compound according to one of the formulae I to III

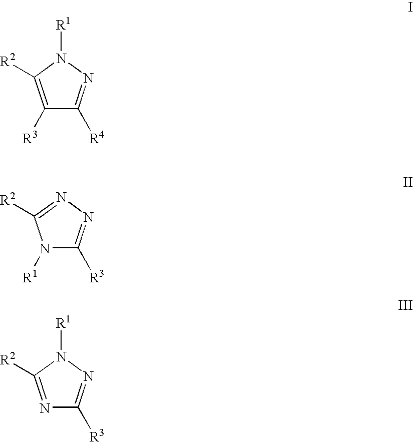

in which

R¹ to R⁴ stand independently of one another for hydrogen or for an alkyl radical having 1 to 25 carbon atoms or, in combination of two or three or four of the radicals R¹ to R⁴, for an aliphatic ring system having 1 to 25 carbon atoms, where in the case of the formula I R² and R³ taken together or R³ and R⁴ taken together may also denote a substituted or unsubstituted (preferably unsubstituted) benzene ring which is fused onto the pyrazole ring for stabilizing blocked polyisocyanates against thermal yellowing. The present invention further relates to compositions comprising blocked polyisocyanates and at least one compound according to formula I to III, to coating materials comprising this composition, and also to coatings and substrates containing these coating materials.

### CROSS REFERENCE TO REVISED PATENT APPLICATION

The present patent application claims the right of priority under 35 U.S.C. Section 119 (a)-(d) of the German Patent Application No. 10 228 730.9, filed Jun. 27, 2002.

### BACKGROUND OF THE INVENTION

1. Field of the Invention

The present invention relates to the use of certain pyrazoles and 1,2,4-triazoles for stabilizing blocked polyisocyanates against thermal yellowing. The present invention further relates to compositions comprising blocked polyisocyanates and at least one of these certain pyrazoles or 1,2,4-triazoles, and also to coating materials comprising this composition, and also to coatings obtainable from these coating materials and to substrates coated with these coating materials.

2. Description of the Related Art

Blocked polyisocyanates are used, for example, in one-component polyurethane baking varnishes (1K PU baking varnishes), particularly for automotive clearcoat materials and for what are known as coil coating materials. In coil coating, rolls of sheet steel (referred to as coils) are unrolled and painted. The products of coil coating are painted steel panels which are used, for example, for producing household appliances such as refrigerators etc. (known as white goods). For these end uses, particularly under overbaking conditions, only slight thermal yellowing of the coating materials is allowed. Overbaking means the exceedance of the normal baking temperature of a coating material. In the case of coil coating, overbaking denotes the exceedance of what is referred to as the peak metal temperature. Thermal yellowing means the yellowing of the coating material at high temperature. High temperatures occur in particular during the baking of the coating materials.

Liebigs Annalen, volume 562, pages 205 to 229 from the year 1949 describes the preparation of blocked polyisocyanates. Blocked polyisocyanates can be prepared by direct reaction of the polyisocyanates with the blocking agent. In the case of C—H-acidic blocking agents (for example malonates) it is possible to use deprotonating agents in order to trigger the reaction of the polyisocyanates with the blocking agent.

DE-A 197 38 497 discloses amine-blocked polyisocyanates stabilized against thermal yellowing.

JP-A 10-306254 discloses blocked polyisocyanates which comprise benzotriazoles.

A contribution to the thermal yellowing of the blocked polyisocyanates during coating is ascribed to the blocking agent. Blocking agents which lead to low thermal yellowing are described in Farbe & Lack, 7/96, volume 102, pages 51 to 58, by Engbert et al. as including 3,5-dimethylpyrazole and 1,2,4-triazole. These, however, have other disadvantages. Thus 3,5-dimethylpyrazole is expensive and certain properties of 1,2,4-triazole as a product make it unsuitable for general use. For example, the blocking of polyisocyanates based on 1,6-diisocyanatohexane (HDI) with 1,2,4-triazole leads to highly crystalline products which are therefore unsuitable for use in solvent-borne paints and coatings.

Other blocking agents such as butanone oxime and diisopropylamine, for example, have the disadvantage of leading to high thermal yellowing.

In order to lessen the disadvantages described above, EP-A 0 654 490 and DE-A 44 16 750 disclose blocked polyisocyanates blocked with mixtures of 1,2,4-triazole and/or 3,5-dimethylpyrazole in combination with further blocking agents. These, however, likewise have the disadvantages described above, albeit to a lesser extent.

EP-A 0 829 500 and DE-A 197 38 497 describe as stabilizers for blocked poly-isocyanates a combination of compounds, one of the compounds containing at least one 2,2,6,6-tetramethylpiperidinyl radical, known as the HALS (hindered amine light stabilizer) radical and the other containing a hydrazide structure. A disadvantage, however, is that the latter are in some cases not available commercially and have to be prepared, for example, by reaction of a cyclic carbonate with hydrazine, necessitating an additional operation. Moreover, some of these compounds possess two isocyanate-reactive groups, leading to high viscosities and thus to an increased solvent fraction in the products. In certain cases, gelling occurs when these compounds are used.

### SUMMARY OF THE INVENTION

The present invention is based on the object of stabilizing polyisocyanates against thermal yellowing.

This object is achieved through the use of a compound according to one of the formulae I to III

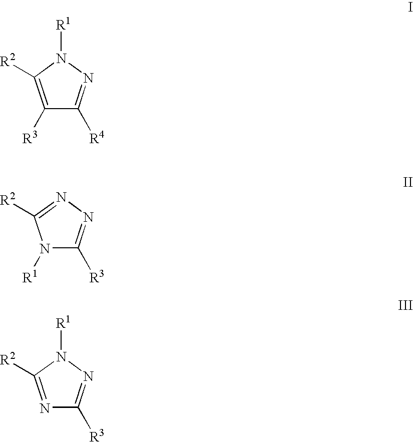

in which

R¹ to R⁴ stand independently of one another for hydrogen or for an alkyl radical having 1 to 25 carbon atoms or, in combination of two or three or four of the radicals R¹ to R⁴, for an aliphatic ring system having 1 to 25 carbon atoms,

where

the case of the formula I R² and R³ taken together or R³ and R⁴ taken together may also denote a substituted or unsubstituted (preferably unsubstituted) benzene ring which is fused onto the pyrazole ring for stabilizing blocked polyisocyanates against thermal yellowing.

Additionally this object is achieved by a composition comprising

A) at least one blocked polyisocyanate and

B) at least one compound according to one of the formulae I to III

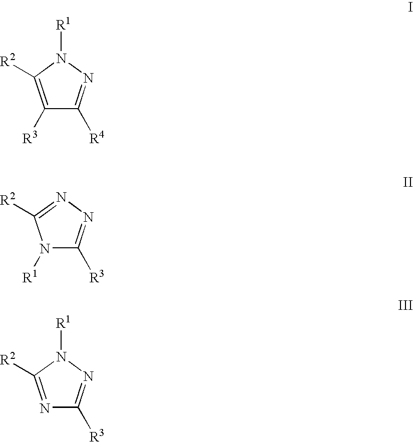

in which

R¹ to R⁴ stand independently of one another for hydrogen or for an alkyl radical having 1 to 25 carbon atoms or, in combination of two or three or four of the radicals R¹ to R⁴, for an aliphatic ring system having 1 to 25 carbon atoms,

where

in the case of the formula I R² and R³ taken together or R³ and R⁴ taken together may also denote a substituted or unsubstituted benzene ring which is fused onto the pyrazole ring.

In one embodiment of the present invention the blocked polyisocyanate is blocked to the extent of more than 90 mol %, preferably exclusively, with compounds other than those specified above under formula I to III.

In one embodiment of the present invention at least 95 mol % of the isocyanate groups of the blocked polyisocyanate are in blocked form.

In one embodiment of the present invention the blocked polyisocyanate contains in total from 5 to 27% by weight of non-blocked and blocked isocyanate groups (calculated as NCO, molecular weight=42).

In one embodiment of the present invention the compound specified under B) has a fraction of from 0.1 to 10% by weight, based on the amount of the blocked polyisocyanate, in the composition of the invention.

In one embodiment of the present invention the composition further comprises

C) further auxiliaries or additives.

In one embodiment of the present invention the fraction of C) in the composition is up to 5% by weight, based on the amount of the blocked polyisocyanate.

The described use and the described composition are provided by the present invention.

The present invention further provides a coating material comprising the composition of the invention.

The present invention further comprises a coating obtainable from this coating material.

The present invention further provides a coated substrate obtainable by coating a substrate with this coating material.

### DESCRIPTION OF THE PREFERRED EMBODIMENTS

Blocked polyisocyanates can be obtained by reacting polyisocyanates (a1)) with blocking agents (a2)) and, where appropriate, with further compounds (a3)) which react with isocyanates (and are referred to as isocyanate-reactive compounds).

Polyisocyanates (a1)) are, in particular, aliphatic, cycloaliphatic, araliphatic and/or aromatic diisocyanates and also any desired polyisocyanates that are prepared by modifying these diisocyanates, are synthesized from at least two diisocyanates and have a uretdione, isocyanurate, allophanate, biuret, iminooxadiazinedione and/or oxadiazinetrione structure, such as are known, for example, from “Polyurethane für Lacke und Beschichtungen”, pages 18 to 35 (M. Bock, Vincentz Verlag, Hannover, 1999), or mixtures of these compounds.

Suitable diisocyanates are, in particular, any desired diisocyanates of the molecular weight range 140 to 400 g/mol which are obtainable by phosgenation or by phosgene-free methods, for example by thermal urethane cleavage, and contain aliphatically, cycloaliphatically, araliphatically and/or aromatically bonded isocyanate groups, such as, for example, 1,4-diisocyanatobutane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)-isocyanato-methylcyclohexane, bis(isocyanatomethyl)norbornane, 1,3- and 1,4-bis(2-isocyanatoprop-2-yl)benzene (TMXDI), 2,4- and 2,6-diisocyanatotoluene (TDI), 2,4′- and 4,4′-diisocyanatodiphenylmethane, 1,5-diisocyanatonaphthalene or any desired mixtures of such diisocyanates.

The polyisocyanates are preferably polyisocyanates or polyisocyanate mixtures of the type mentioned containing exclusively aliphatically and/or cycloaliphatically attached isocyanate groups.

More preferred polyisocyanates are polyisocyanates or polyisocyanate mixtures having an isocyanurate structure and/or biuret structure which are based on HDI, IPDI and/or 4,4′-diisocyanatodicyclohexylmethane, or mixtures of these compounds.

Suitable blocking agents (a2)) are known from the prior art and are, for example, alcohols, lactams, oximes, malonates, alkyl acetoacetates, phenols, and amines, such as butanone oxime, diisopropylamine, diethyl malonate, ethyl acetoacetate, acetone oxime, ε-caprolactam or any desired mixtures of these blocking agents. Preferred blocking agents are butanone oxime, diethyl malonate, diisopropylamine and ε-caprolactam or mixtures of these compounds. More preferred blocking agents are butanone oxime and/or diisopropylamine.

The isocyanate-reactive compounds (a3)) are, for example, compounds containing one or more isocyanate-reactive amino and/or hydroxyl groups, such as, for example, monoalcohols, polyalcohols, monoamines, polyamines and amino alcohols or mixtures of these compounds. These are used in what is termed a prelengthening or advancement reaction in order to adapt the service properties of the blocked polyisocyanates of the invention to the particular profile of requirements. Thus it is possible, for example, to raise the crosslinking density by increasing the average NCO functionality in the finished curing agent. The elasticity can be influenced by components which lead to greater hardness or softness. The crystallization tendency can be influenced.

Preference is given to using 1,6-hexanediol, 2-ethylhexane-1,3-diol, 1,3-butanediol, 1,4-butanediol, 2,2,4-trimethyl-1,3-pentanediol, 2,4,4-trimethyl-1,3-pentanediol, trimethylolpropane, polyester polyols, polyacrylate polyols, polycarbonate polyols and/or polyurethane polyols or mixtures of these compounds.

The molar ratio of the isocyanate groups of component al) to the sum of the isocyanate-reactive groups of components a2) and a3) is preferably 0.80 to 1.05, with particular preference 0.95 to 1.00; more preferably the ratio is 1.00. Where compounds containing isocyanate-reactive groups are employed as component B), the ratio is preferably 0.80 to 1.00, in particular 0.95 to 1.00; with particular preference the ratio is 1.00.

The proportion in mol % of the isocyanate-reactive groups of component a3) as a fraction of the total of the isocyanate-reactive groups of components a2) and a3) is, where appropriate, preferably 1% to 50%, in particular 3% to 30%, with particular preference 4% to 8%.

The preparation of the blocked polyisocyanates from components a1), a2) and, where appropriate, a3) takes place by reaction of these components in accordance with the methods known from the prior art. These are described, for example, in Liebigs Annalen, volume 562, pages 205 to 229 from the year 1949. The blocked polyisocyanates can be prepared by direct reaction of the polyisocyanates with the blocking agent. In the case of C—H-acidic blocking agents (for example malonates) it is possible to use deprotonating agents in order to trigger the reaction of the polyisocyanates with the blocking agent.

Component B) of the composition of the invention comprises compounds according to one of the formulae I to III or any desired mixtures of these compounds

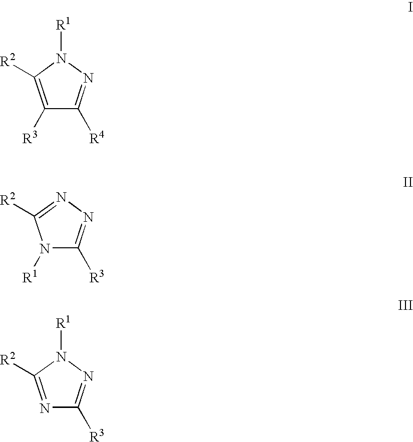

in which

R¹ to R⁴ stand independently of one another for hydrogen or for an alkyl radical having 1 to 25 carbon atoms or in combination of two or three or four of the radicals R¹ to R⁴ for an aliphatic ring system having 1 to 25 carbon atoms, where in the case of the formula I R² and R³ taken together or R³ and R⁴ taken together may also denote a substituted or unsubstituted (preferably unsubstituted) benzene ring which is fused onto the pyrazole ring.

Preference is given to compounds of the general formulae I to III in which R¹ stands for a hydrogen atom and R², R³ and R⁴ stand independently of one another for hydrogen or an alkyl radical having 1 to 6 carbon atoms or in combination of two or three of the radicals R² to R⁴ for an aliphatic ring system having 1 to 25 carbon atoms, or any desired mixtures of these compounds.

More preferred compounds of the general formulae I to III are those in which R¹ stands for a hydrogen atom and R², R³ and R⁴ stand independently of one another for hydrogen or an alkyl radical having 1 to 6 carbon atoms, or any desired mixtures of these compounds.

With particular preference the compounds are 3,5-dimethylpyrazole, 3,5-dimethyl-1,2,4-triazole and 1,2,4-triazole or any desired mixtures of these compounds.

The compounds according to one of the formulae I to III (component B of the composition of the invention) are available commercially or can be prepared by known processes. The corresponding preparation processes are known to the person skilled in the art. The customary processes of heterocycle synthesis can be used. For example, hydrazines can be condensed with dicarbonyl compounds.

Non-B) auxiliaries and additives C), which may be used where appropriate, are, for example, antioxidants such as 2,6-di-tert-butyl-4-methylphenol, UV absorbers of the 2-hydroxyphenylbenzotriazole type or light stabilizers of the type of the HALS compounds substituted on the nitrogen atom, such as Tinuvin® 292 (Ciba Spezialitäten GmbH, Lampertheim, Del.), or other commercially customary stabilizers, as described, for example, in “Lichtschutzmittel für Lacke” (A. Valet, Vincentz Verlag, Hannover, 1996) and “Stabilization of Polymeric Materials” (H. Zweifel, Springer Verlag, Berlin, 1997, Appendix 3, pp. 181-213), or any desired mixtures of these compounds.

The composition of the invention can be prepared by mixing components A), B) and, where appropriate, C) in any order, it being possible for each of the components to be in a form in which they are dissolved in solvents and it being possible additionally for further solvents to be added. Mixing can take place in a temperature range from 0 to 100° C., preferably in a temperature range from 20 to 80° C., with greater preference in a temperature range from 20 to 50° C.

Furthermore, one more preferred embodiment of the above-described process for preparing the polyisocyanates of the invention may be characterized in that component B) is mixed with component A) during and/or immediately following the preparation of the said component A). Where compounds are used as component B) that contain isocyanate-reactive groups they are not added until ≧99% of the NCO groups of a1) and the isocyanate-reactive group of components a2) and a3) have reacted. Where appropriate, further auxiliaries and additives C) may be added during and/or following the preparation of component A). For the preparation of component A) it is possible for each of components a1), a2) and a3) to be in a form in which they are dissolved in solvents, and solvents can be added as well. The reaction of components a1), a2) and a3) may be carried out within a temperature range from 0 to 200° C., preferably within a temperature range from 20 to 130° C. with particular preference from 20 to 90° C. The blocking reaction and also the advancement reaction may be accelerated by the use of catalysts which are known in polyurethane chemistry. This may be advantageous, for example, when components a2 and/or a3 contain hydroxyl groups.

Suitable solvents are the paint solvents which are customary per se, such as ethyl acetate, butyl acetate, 1-methoxypropyl 2-acetate, 3-methoxy-n-butyl acetate, acetone, 2-butanone, 4-methyl-2-pentanone, cyclohexanone, toluene, xylene, N-methylpyrrolidone, chlorobenzene or white spirit, for example. Mixtures containing in particular aromatics with relatively high degrees of substitution, such as are sold, for example, under the names Solvent Naphtha, Solvesso® (Exxon Chemicals, Houston, USA), Cypar® (Shell Chemicals, Eschborn, Del.), Cyclo Sol® (Shell Chemicals, Eschborn, Del.), Tolu Sol® (Shell Chemicals, Eschborn, Del.), Shellsol® (Shell Chemicals, Eschborn, Del.), are likewise suitable. However, it is also possible to use alcohols, such as isobutanol, for example, as soon as the NCO groups of component a1) have been completely consumed by reaction with the isocyanate-reactive groups of components a2) and a3). Preferred solvents are acetone, butyl acetate, 2-butanone, 1-methoxypropyl 2-acetate, xylene, toluene, mixtures containing, in particular, aromatics with relatively high degrees of substitution, such as are sold, for example, under the names Solvent Naphtha, Solvesso® (Exxon Chemicals, Houston, USA), Cypar® (Shell Chemicals, Eschborn, Del.), Cyclo Sol® (Shell Chemicals, Eschborn, Del.), Tolu Sol® (Shell Chemicals, Eschborn, Del.), Shellsol® (Shell Chemicals, Eschborn, Del.).

The blocked polyisocyanates of the invention are those in which preferably at least 95%, with particular preference at least 98%, more preferably at least 99.5% of the isocyanate groups are present in blocked form, containing 5-27% by weight, preferably 5-22% by weight, with very particular preference 7-19% by weight, of non-blocked and blocked isocyanate groups (calculated as NCO).

The blocked polyisocyanates of the invention contain preferably from 0.1 to 10% by weight, with particular preference 0.5-7% by weight, more preferably 1-4% by weight of component B), preferably in chemically unbonded form, and up to 5% by weight of component C, the amounts of components A), B) and C) preferably adding up to 100% by weight.

Component B) here is preferably in chemically unbonded form and functions preferably as a stabilizing additive. The polyisocyanates of the invention wherein compounds containing isocyanate-reactive groups are used as component B) are therefore different from the systems with hybrid blocking by five-membered-ring heteroaromatics that are known from EP-A 0 654 490 and DE-A 44 16 750.

The present invention is based on the surprising observation that, following the addition of specific compounds from the group consisting of substituted and unsubstituted five-membered-ring heteroaromatics having two or three nitrogen atoms in the ring structure, blocked polyisocyanates exhibit significantly lower thermal yellowing in 1K coating applications than comparable blocked polyisocyanates without this addition.

The compositions of the invention can be used as a constituent in coating materials. In particular they can be used as crosslinkers for organic polyhydroxyl compounds in polyurethane one-component baking varnishes (polyurethane 1K baking varnishes), particularly for automotive clearcoat materials or coil coating.

These coating materials may comprise conventional further constituents, solvents and other auxiliaries and additives.

These coating materials may be used for coating various substrates, particularly for coating metals, especially steel. The metals may have already been coated with other coating films, so that by coating with the coating material comprising the composition of the invention a further coating film is applied.

The advantages achieved with the polyisocyanates of the invention consist in a marked improvement in the yellowing resistance on overbaking (e.g. exceedance of the normal peak metal temperature of 232° C. in the case of coil coating or 140° C. in the case of baking of automotive clearcoat materials) and during heat conditioning (e.g. during storage at 120° C. for 120 h, as is required for “white goods”).

It is therefore possible, for the preparation of the blocked polyisocyanates of the invention, to use readily available blocking agents, such as malonates, diisopropylamine and butanone oxime, for example, and to obtain comparatively low thermal yellowing, such as is otherwise achievable only with blocking agents which are costly or cannot be widely used, such as 3,5-dimethylpyrazole and 1,2,4-triazole, for example.

A further advantage of the polyisocyanates of the invention both over the poly-isocyanates fully blocked with 3,5-dimethylpyrazole and 1,2,4-triazole and over the hybrid-blocked polyisocyanates described in DE-A 198 56 968 and DE-A 044 16 750 is that it is possible to use blocking agents such as, for example, diisopropylamine or diethyl malonate whose deblocking temperature is lower than that of the more yellowing-stable blocking agents, such as 1,2,4-triazole and 3,5-dimethylpyrazole, without having to accept poorer yellowing stability, something which can have economic advantages or lead to better film properties, for example under underbaking conditions.

As compared with the polyisocyanates described in EP-A 0 829 500 and DE-A 197 38 497 the advantage of improved yellowing stability, lower viscosity and/or better availability of the compounds effective at stabilizing is maintained.

### EXAMPLES

In the examples below all percentages are % by weight, except where specified otherwise.

The solids contents stated for the products are calculated figures which corresponds to the fraction of the components which are not used as solvents.

### Example 1

### (Comparative, without the use of Five-Membered-Ring Heteroaromatics B)

In accordance with DE-A 197 38 497, Example 1 an unstabilized, diisopropylamine-blocked polyisocyanate based on a mixture of isocyanurate-containing paint polyisocyanates of HDI and IPDI was prepared. The blocked NCO group content was 8.5%. The solids content was calculated to be 65%. Batch

| | | |
|---|---|---|
| 140.0 g | (0.7 eq) | HDI trimer, NCO content about 21%, monomeric |
| | | 1,6-diisocyanatohexane content about 0.2%, |
| | | viscosity at 23° C. about 3000 mPas |
| 105.0 g | (0.3 eq) | IPDI trimer, NCO content about 12%, 70% strength |
| | | solution in solvent naphtha |
| 106.0 g | (1.05 eq) | diisopropylamine |
| 70.0 g | | methoxypropyl acetate |
| 70.5 g | | isobutanol |
| 491.5 g | (1.0 eq) | blocked polyisocyanate, |
| | | solids 65% (calculated) |
| | | blocked NCO content: 8.5% (calculated) |

### Procedure:

The two polyisocyanates were introduced initially with methoxypropyl acetate and this initial charge was heated to 50° C. With stirring, diisopropylamine was added in portions, accompanied by the observation of a slight exotherm. After the end of addition, stirring was continued at 70° C. for 30 minutes. During this time, it was possible to examine the disappearance of the NCO groups by means of IR spectroscopy. As soon as NCO groups were no longer detectable by IR spectroscopy, the mixture was diluted with isobutanol and left to cool.

The viscosity of the product following dilution with 1-methoxypropyl 2-acetate to a solids content of 60% was 1500 mPas at 23° C.

### Example 2

### (Comparative, Stabilization by Combination of Hydrazide and HALS Compound)

In accordance with DE-A 197 38 497, Example 2 a diisopropylamine-blocked polyisocyanate stabilized with a hydrazide and with a HALS compound and based on a mixture of isocyanurate-containing paint polyisocyanates of HDI and IPDI was prepared. The blocked NCO group content was 8.5%. The solids content was calculated to be 65%. The viscosity was 1300 mPas at 23° C. Following dilution with 1-methoxypropyl 2-acetate to a solids content of 60% the viscosity was 4000 mPas at 23° C.

### Example 3

### (Inventive)

In accordance with DE-A 197 38 497, Example 1 an unstabilized, diisopropylamine-blocked polyisocyanate based on a mixture of isocyanurate-containing polyisocyanates of HDI and IPDI was prepared and was admixed with 3%, based on the solids content, of 1,2,4-triazole as starting compound B) of formula

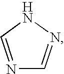

in solution in 1-methoxypropyl 2-acetate. The blocked NCO group content was 7.6%. The solids content was calculated to be 60%. The viscosity was 1300 mPas at 23° C.

### Example 4

### (Inventive)

In accordance with DE-A 197 38 497, Example 1 an unstabilized, diisopropylamine-blocked polyisocyanate based on a mixture of isocyanurate-containing polyisocyanates of HDI and IPDI was prepared and was admixed with 3%, based on the solids content, of 3,5-dimethylpyrazole (starting compound B)) of formula

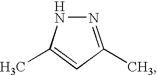

in solution in 1-methoxypropyl 2-acetate. The blocked NCO group content was 7.6%. The solids content was calculated to be 60%. The viscosity was 1300 mPas at 23° C.

From comparing the inventive examples and the comparative examples it becomes clear that the stabilization effected with the stabilizer combination described in DE-A 197 38 497, Example 2 in comparison to the unstabilized polyisocyanate from Example 1 leads to a marked increase in viscosity, whereas this is not the case with the polyisocyanates of the invention from Examples 3 and 4.

### Example 5

### (Use in Coil Coating, Inventive and Comparative)

Based on the polyisocyanate from Example 1 and on the hydroxy-functional polyesterpolyol Alkynol® 1665 from Bayer AG, Leverkusen, Germany, a realistic coil coating paint was produced. Also used were the titanium dioxide Tronox® R-KB-4 from Kerr-McGee, Krefeld-Uerdingen, Germany and also, as further additives, cellulose acetobutyrate CAB 531-1 from Krahn Chemie GmbH, Hamburg, Germany dibutyltin dilaurate from Brenntag, Mühlheim/Ruhr, Germany, a levelling assistant based on an n-butyl acrylate polymer (Acronal® 4 F from BASF AG, Ludwigshafen, Germany), and, as solvent, a mixture of high-boiling aromatic hydrocarbons (Solvesso® 200 S from Deutsche Exxon, Cologne, Germany).

The paints were prepared such that the molar ratio of hydroxyl groups of the polyester to the blocked NCO groups of polyisocyanate was 1:1, the weight ratio of the nonvolatile constituents of the polyisocyanate and of the polyester to the pigment was 1:1. Based on the solids content of the polyisocyanate and of the polyester, the paints contained 0.3% by weight dibutyltin dilaurate, 1.2% by weight CAB 531-1 and 0.3% Acronal® 4 F. The application viscosity was adjusted to a figure of about 100 s (DIN EN ISO 2431, cup with 5 mm nozzle/23° C.) by dilution with Solvesso® 200 S.

Paint 1 was prepared based on the polyisocyanate from Example 1 (comparative).

Paint 2 was prepared based on the polyisocyanate from Example 2 (comparative).

Paint 3 was prepared based on the polyisocyanate from Example 3 (inventive).

Paint 4 was prepared based on the polyisocyanate from Example 4 (inventive).

The paints were applied to a chromated aluminium panel and baked either at peak metal temperatures (PMT) of 232° C. (baking) or 254° C. (overbaking). The thickness of the films was between 20 and 22 μm.

The Berger whiteness of the aluminium panels thus coated was measured. The Berger whiteness can be determined by the CIELAB method of 1976 (DIN 6174). The values measured for L, a and b give rise to Rₓ, R_{y} and R_{z}. For the Berger whiteness it is the case that W=R_{y}+3 (R_{z}-Rₓ).

The results are summarized in the following table:

| | Comparative | Comparative | Inventive | Inventive |
|---|---|---|---|---|
| Paint | 1 | 2 | 3 | 4 |
| Berger whiteness | 93.7 | 93.4 | 93.4 | 93.8 |
| 232° C. | | | | |
| Berger whiteness | 93.0 | 92.8 | 94.4 | 93.3 |
| 254° C. | | | | |
| Δ whiteness | 0.7 | 0.6 | −1.0 | 0.5 |

It is clear that the two polyisocyanates of the invention as compared with the prior art polyisocyanate described in DE-A 197 38 497, Example 2 and with the unstabilized polyisocyanate from Example 1 lead to paints having lower thermal yellowing (Δ whiteness), in some cases much lower, during overbaking. The metal panels baked at a PMT of 232° C. were stored at 120° C. for 120 h and the difference in the Berger whiteness before and after storage was determined. As is evident from the table below, the fall in whiteness as a result of heat conditioning is much lower in the case of the inventive paints than in the case of the unstabilized paint.

| | Comparative | Inventive | Inventive |
|---|---|---|---|
| Paint | 1 | 3 | 4 |
| Δ whiteness | 2.3 | 2.0 | 1.4 |

### Example 6

### (Use in Automotive Clearcoat Material, Inventive and Comparative)

Based on the polyisocyanates from Examples 1, 3 and 4 and on the hydroxy-functional polyacrylate polyol Desmophen® A 870 from Bayer AG, Leverkusen, Germany, automotive clearcoat materials were prepared. This was done by mixing the polyacrylate polyol and the corresponding polyisocyanates in the ratio of their equivalent weights (NCO:OH=1). The application viscosity was adjusted to a figure of about 25 to 30 s (DIN EN ISO 2431, cup with 5 mm nozzle/23° C.) by dilution with 1-methoxypropyl 2-acetate. Based on the fraction of the nonvolatile constituents of the polyisocyanate and of the polyester, the paints contained 1.0% by weight dibutyltin dilaurate.

Paint 1 was prepared based on the polyisocyanate from Example 1. (comparative)

Paint 2 was prepared based on the polyisocyanate from Example 3. (inventive)

Paint 3 was prepared based on the polyisocyanate from Example 4. (inventive)

The paints were applied to aluminium panels prepared with a solvent-borne, commercially customary, white basecoat material which is dried at room temperature, from, for example, Spiess/Hecker, Cologne, Germany, and baked at 140° C. (baking) for 30 minutes. The film thickness was between 30 and 40 μm. The panels were then baked again at 160° C. (overbaking) for 30 minutes, and the difference in the yellowing values after baking and overbaking (total Δb) was measured. The total Δb value can be determined by CIELAB (CIELAB method of 1976 in accordance with DIN 6174; b is determined directly by this method).

The results are summarized in the table below:

| | Paint | | |
|---|---|---|---|
| | 1 | 2 | 3 |
| | Comparative | Inventive | Inventive |
| Thermal yellowing on | 2.3 | 1.3 | 0.9 |
| overbaking (total Δb) | | | |

It is clear that, as compared with the unstabilized polyisocyanate from Example 1, the two polyisocyanates of the invention lead to paints having much less thermal yellowing during overbaking (total Δb).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method for stabilizing blocked polyisocyanates against thermal yellowing, comprising mixing a blocked polyisocyanate with at least one compound according to one of the formulae I to III 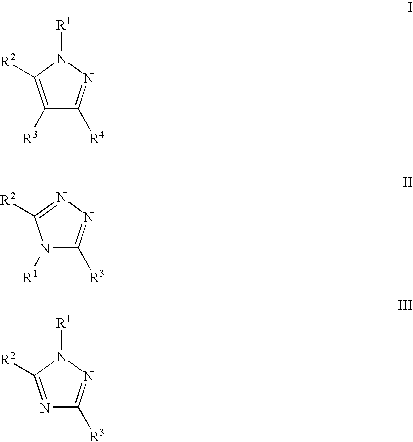
in which
R¹ to R⁴ stand independently of one another for hydrogen or for an alkyl radical having 1 to 25 carbon atoms or, in combination of two or three or four of the radicals R¹ to R⁴, for an aliphatic ring system having 1 to 25 carbon atoms,
where
in the case of the formula I R² and R³ taken together or R³ and R⁴ taken together may also denote a substituted or unsubstituted benzene ring which is fused onto the pyrazole ring.

2. A composition comprising
A) at least one blocked polyisocyanate and
B) at least one compound according to one of the formulae I to III 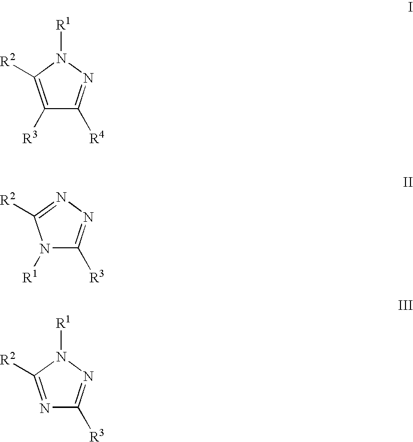
in which
R¹ to R⁴ stand independently of one another for hydrogen or for an alkyl radical having 1 to 25 carbon atoms or, in combination of two or three or four of the radicals R¹ to R⁴, for an aliphatic ring system having 1 to 25 carbon atoms,
where
in the case of the formula I R² and R³ taken together or R³ and R⁴ taken together may also denote a substituted or unsubstituted benzene ring which is fused onto the pyrazole ring.

3. The composition according to claim 2, wherein the blocked polyisocyanate is blocked exclusively with compounds other than compounds according to one of the formulae I to III 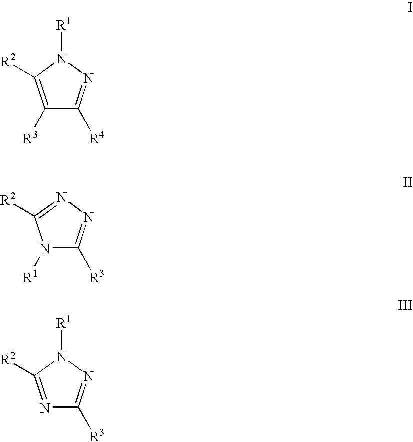
is which
R¹ to R⁴ stand independently of one another for hydrogen or for an alkyl radical having 1 to 25 carbon atoms or, in combination of two or three or four of the radicals R¹ to R⁴, for an aliphatic ring system having 1 to 25 carbon atoms,
where
in the case of the formula I R² and R³ taken together or R³ and R⁴ taken together may also denote a substituted or unsubstituted benzene ring which is fused onto the pyrazole ring.

4. The composition according to claim 2, wherein at least 95 mol % of the isocyanate groups of the blocked polyisocyanate are in blocked form.

5. The composition according to claim 2, wherein the blocked polyisocyanate contains in total from 5 to 27% by weight of non-blocked and blocked isocyanate groups (calculated as NCO, molecular weight=42).

6. The composition according to claim 2, wherein the at least one compound according to one of the formulae I to III has a fraction of from 0.1 to 10% by weight, based on the amount of the blocked polyisocyanate.

7. The composition according to claim 2, further comprising further auxiliaries or additives.

8. The composition according to claim 7, wherein the fraction of further auxiliaries or additives in the composition is up to 5% by weight, based on the amount of the blocked polyisocyanate.

9. A coating material comprising the composition of claim 2.

10. A coating obtained from the coating material of claim 9.

11. A coated substrate obtained by coating a substrate with the coating material of claim 9.
